(19) United States
(12) Patent Application Publication
(10) Pub. No.: US 2010/0154588 A1
(43) Pub. Date: Jun. 24, 2010

(54) IRON-BASED POWDER AND COMPOSITION THEREOF

(76) Inventors: Sigurd Berg, Hoganas (SE); Ulf Engström, Hoganas (SE); Caroline Larsson, Nyhamnslage (SE)

Correspondence Address: BUCHANAN, INGERSOLL & ROONEY PC, POST OFFICE BOX 1404, ALEXANDRIA, VA, 22313-1404, US

(21) Appl. No.: 12/664,139

(22) PCT Filed: Jun. 12, 2008
(86) PCT No.: PCT/SE08/50709

§ 371 Date: Feb. 16, 2010

Related U.S. Application Data
(60) Provisional application No. 60/943,889, filed on Jun. 14, 2007.

(30) Foreign Application Priority Data
Jun. 14, 2007 (SE) 0701446-7

(51) Int. Cl. B32B 15/02; C22C 38/16; B22F 1/02; B22F 3/12

(52) U.S. Cl. 75/246; 420/92; 428/570; 419/38; 419/39

(57) ABSTRACT

A water-atomized iron-based powder is provided that is pre-alloyed with 0.75-1.1% by weight of Ni, 0.75-1.1% by weight of Mo and up to 0.45% by weight of Mn, and further including 0.5-3.0%, preferably 0.5-2.5% and most preferably 0.5-2.0% by weight of Cu, and inevitable impurities, the balance being Fe.

### FIELD OF THE INVENTION

The present invention concerns an alloyed iron-based powder as well as an alloyed iron-based powder composition comprising the alloyed iron-based powder, graphite, lubricants and eventually other additives. The composition is designed for a cost effective production of pressed and sintered components having good mechanical properties.

### BACKGROUND OF THE INVENTION

In industries the use of metal products manufactured by compacting and sintering metal powder compositions is becoming increasingly widespread. A number of different products of varying shape and thickness are being produced and the quality requirements are continuously raised at the same time as it is desired to reduce the cost. This is particular true for P/M parts for the automotive market, which is an important market for the P/M industry. In the P/M industry alloying elements such as Mo, Ni and Cu have commonly been used for improving the properties of pressed and sintered components. However, these alloying elements are costly and it would therefore be desirable if the contents of these alloying elements could be kept as low as possible while maintaining sufficient properties of the pressed and sintered component.

In order to achieve high strength of a pressed and sintered component the hardenability of the material is essential. A cost effective way of hardening a P/M component is the so called sinter hardening method where the component is hardened directly after sintering during the cooling step. By carefully choosing the alloying elements, and content of the elements, sinter hardening may be achieved at cooling rates normally applied in conventional sintering furnaces.

Another factor of importance when producing pressed and sintered components is the variation of dimensions between different sintered parts which shall be as small as possible in order to avoid costly machining after sintering. Furthermore, it is desirable that the dimensional change, between the component in the green stage, i.e. after pressing, and the component after it has been sintered, is low and that the influence of variations in carbon content of the dimensional change is a low as possible in order to avoid introduction of stresses and possible distortion of the components as this also will lead to costly machining. This is of special importance for materials having high hardness and strength as machining costs increases with increasing hardness and strength.

Another important factor is the possibility of recycling scrap from the automotive industry at preparation of the melt to be atomized which has great environmental impact. In this respect the possibility of accepting contents of up to 0.3% Mn in the alloyed iron-based powder is critical as such levels of Mn is common in recycled steel scrap.

Iron-based powders alloyed with Ni, Mo and Cu are widely used as alloying elements and known from a variety of patent applications. As an example, U.S. Pat. No. 6,068,813 to Semel, reveals a powder composition comprising a prealloyed iron and molybdenum powder having a content of 0.10-2.0 weight % of molybdenum, admixed with a copper containing powder and a nickel containing powder, whereby the copper containing powder and the nickel containing powder are bonded to the iron-molybdenum powder by means of a binding agent. The powder composition containing 0.5-4.0% by weight of copper and 0.5-8.0% by weight of nickel. The iron-based powder used in the examples have a content of Mo of 0.56% by weight, a content of Ni of 1.75% or 4.00% by weight and a Cu content of 1.5% by weight.

Another example in the patent literature concerning pre-alloyed powders containing Ni, Mo and Mn, which may be mixed with Cu— powder is U.S. Pat. No. 4,069,044 to Mocarski. This patent disclose a method of making a powder, the powder being suitable for producing powder-forged articles. Results from tests of forged components according to a preferred composition containing 0.4-0.65% of Mo and Ni are reported. The patent also mention a variation containing pre-alloyed iron-based powder with 0.2-1.0% Ni, 0.2-0.8% Mo and 0.25-0.6% of Mn admixed with graphite and Cu— or Cu containing powders giving a composition containing 0.2-2.1% Cu to be compacted, suitable sintered at 2250-2350° F., and hot forged. However, no test results are shown for Ni contents above 0.60 wt %, neither for Mo contents above 0.65 wt %.

For sinter hardening applications there exists a lot of commercially available powders such as Ancorsteel 737 SH, available from Hoeganaes Corp., NJ, US, and Atomet 4701, available from Quebec Metal Powders, Canada. The mentioned iron-based powders are alloyed with Mo, Ni and Mn and ATOMET 4701 is additionally alloyed with Cr. Ancorsteel 737 SH is a prealloyed steel powder having a chemical composition of 0.42% Mn, 1.25% Mo, 1.40% Ni. The chemical composition of Atomet 4701 is 0.45% Mn, 1.00% Mo, 0.9% Ni and 0.45% Cr.

### OBJECTS OF THE INVENTION

It is an object of the invention to provide a new iron-based powder and/or powder composition thereof, having low contents of Mo, Ni and Cu.

Further objects of the invention are:

provide a new iron-based powder and/or powder composition thereof, suitable for producing compacted and sinter hardened components.

provide a new iron-based powder and/or powder composition thereof, suitable for producing sintered products having low dimensional change between green stage and sintered stage.

provide a new iron-based powder and/or powder composition thereof, where the influence from variations in carbon content on the dimensional change is as low as possible.

provide a new iron-based powder and/or powder composition thereof, which iron-based alloyed powder comprises Mn up to 0.45 weight-% allowing the iron-based alloyed powder to be produced from cheap scrap.

### SUMMARY

At least one of the above mentioned objects and/or problems are met by providing an iron-based powder being pre-alloyed with 0.75-1.1 wt % (% by weight) Mo, preferably more than 0.8 wt % Mo, 0.75-1.1 wt % Ni, up to 0.45 wt % Mn and inevitable impurities.

The iron-based powder having at most 0.25 wt % of oxygen, preferably at most 0.20 wt % O and most preferably at most 0.15 wt % O. The iron-based powder furthermore having 0.5-2.5 wt % Cu present as: 1) diffusion bonded to the surface of the pre-alloyed iron-based powder, and/or 2) bonded by means of a binding agent to the surface of the pre-alloyed iron-based powder, and/or 3) admixed with the iron-based powder. Further a powder composition thereof containing the iron-based powder, graphite, lubricants and optionally machinability enhancing agents

The content of graphite is preferably in the range of 0.4-0.9% by weight of the powder composition, more preferably in the range of 0.5-0.9 wt % and the content of lubricant is preferably in the range of 0.05-1.0% by weight of the powder composition.

In the preferred embodiment Cu is diffusion bonded to the surface of the pre-alloyed iron-based powder.

According to an embodiment of the invention at least one of graphite, lubricants and machinability improving agents are bonded to the surface of the pre-alloyed iron-based powder.

### DETAILED DESCRIPTION OF THE INVENTION

Preparation of the Alloyed Iron-Based Powder

The alloyed iron-based powder of the invention can be readily produced by subjecting a steel melt prepared to have the above-defined composition of the alloying elements Ni, Mo and Mn to any known water atomising method.

Amount of Mo

Mo serves to improve the strength of steel through improvement of the hardenability and also through solution and precipitation hardening. It has been found that to ensure that enough amount of martensite is formed at normal cooling rates the amount of Mo should be in the range of 0.75-1.1% by weight. However, preferably the content of Mo is more than 0.8 wt %, more preferably more than 0.85 wt % to ensure that enough amount of martensite is formed at normal cooling rates.

Amount of Ni

Ni is added to P/M steel to increase strength and ductility. Ni addition increases also the hardenability of the steel. Addition of Ni less than 0.75 wt % will have an insufficient influence on the mechanical properties whereas additions above 1.1 wt % will not add any further improvements to the intended use of the steel.

Amount of Mn

Mn improves the strength of the steel by improving hardenability and through solution hardening. However if the amount of Mn becomes to high the ferrite hardness will increase through solution hardening, leading to lower compressibility of the powder. Amounts of Mn up to 0.45 wt % can be accepted as the decrease of the compressibility will be almost negligible, preferably the amount of Mn is lower than 0.35 wt %. If the amount of Mn is less than 0.08% it is not possible to use cheap recycled material that normally has a Mn content above 0.08%, unless a specific treatment for the reduction of Mn during the course of the steel manufacturing is carried out. Thus, the preferred amount of Mn according to the present invention is 0.09-0.45%

C Amount

The reason why C in the alloyed iron-based powder is not larger than 0.02 wt %, preferably not larger than 0.01 wt %, is that C is an element, which serves to harden the ferrite matrix through interstitial solid solution hardening. If the C content exceeds 0.02% by weight, the powder is hardened considerably, which results in a too poor compressibility.

O Amount

The amount of O should not exceed 0.25% by weight, O content is preferably limited to 0.2% by weight and most preferably to 0.15% by weight.

Inevitable Impurities

The total amount of inevitable impurities in the alloyed iron-based powder should not exceed totally 0.5% by weight.

Amount of Cu

Particulate Cu is often used in P/M industry as copper particles melts before the sintering temperature is reached thus increasing the diffusion rate and creating sintering necks by wetting. Addition of Cu will also increase the strength of the component. Preferably copper is bonded to the iron-based powder to avoid segregation in the composition which may lead to uneven distribution of copper and varying properties in component, but it would also be possible admixing Cu with the iron-based powder. Any known method of diffusion annealing Cu— particles or Cu— oxide particles to the iron-based powder may be applied as well as bonding Cu— particles to the iron-base powder by an organic binder. The amount of Cu should be between 0.5-3.0% by weight, preferably between 0.5-2.5% by weight, more preferably 0.5-2.0 wt %.

Graphite

Graphite is normally added to a P/M composition in order to improve the mechanical properties. Graphite also acts a reducing agent decreasing the amount of oxides in the sintered body further increasing the mechanical properties. The amount of C in the sintered product is determined by amount of graphite powder added to the alloyed iron-based powder composition. In order to reach sufficient properties of the sintered component the amount of graphite should be 0.4-0.9% by weight of the composition, preferably 0.5-0.9 wt %.

Lubricant

A lubricant may also by added to the alloyed iron-based powder composition to be compacted. Representative examples of lubricants used at ambient temperatures are Kenolube®, ethylene-bis-stearamide (EBS), metal stearates such as Zn-stearate, fatty acid derivates such as oleic amide, glyceryl stearate and polethylene wax.

Representative examples of lubricants used at elevated temperatures (high temperature lubricants) are polyamides, amide oligomers, polyesters. The amount of lubricants added is normally up to 1% by weight of the composition.

Other Additives

Other additives which optionally may be used according to the invention include hard phase materials, machinability improving agents and flow enhancing agents.

Compaction and Sintering

Compaction may be performed in an uniaxially pressing operation at ambient or elevated temperature at pressures up to 2000 MPa although normally the pressure varies between 400 and 800 MPa.

After compaction, sintering of the obtained component is performed at a temperature of about 1000° C. to about 1400° C. Sintering in the temperature range of 1050° C. to 1200° C. leads to a cost effective manufacture of high performance components.

The invention is further illustrated by the following non-limiting examples

### Example

This example illustrates that high tensile strength, at the same level as a material having higher content of the alloying elements Cu, Ni and Mo can be obtained for components produced from P/M compositions according to the invention.

An alloyed iron-based powder having a content of 0.9% by weight of Mo, 0.9% by weight of Ni and 0.25% by weight of Mn was produced by subjecting a steel melt to water atomization. Annealing of the raw water atomized powder was conducted in a laboratory furnace at a temperature of 960° C. in an atmosphere of moist hydrogen. Further, to the annealed powder were added different amount of cuprous oxide, giving powders having contents of 1%, 2% and 3% by weight of diffusion bonded copper respectively. The diffusion bonding or annealing was carried out in a laboratory furnace at 830° C. in an atmosphere of dry hydrogen. The annealed powders were crushed, milled and sieved and the resulting powder having 95% of the particles less than about 180 μm.

A first reference composition, composition nr 10, was based on the iron-based powder Ancorsteel 737, available from Hoeganaes Corp. NJ, US admixed with 2 wt % copper powder and 0.75% graphite.

Three further reference compositions, compositions 11-13, were based on a pre-alloyed powder iron-based powder having a content of 0.6% Mo, 0.45% Ni, and 0.3% Mn admixed with 2% copper powder and graphite of 0.65%, 0.75%, and 0.85% respectively.

Powder compositions according to the invention and reference material were prepared by adding different amounts of graphite and 0.8% by weight of an EBS lubricant. Table 1 shows the different compositions.

TABLE 1
Tested compositions.

| | Mo-content, | Ni-content | Mn-content, | Cu-content | Graphite. |
|---|---|---|---|---|---|
| | wt % of | wt % of | wt % of | wt % of | wt % of |
| Composition No | powder | powder | powder | powder | composition |
| 1 | 0.9 | 0.9 | 0.25 | 1 | 0.65 |
| 2 | 0.9 | 0.9 | 0.25 | 1 | 0.75 |
| 3 | 0.9 | 0.9 | 0.25 | 1 | 0.85 |
| 4 | 0.9 | 0.9 | 0.25 | 2 | 0.65 |
| 5 | 0.9 | 0.9 | 0.25 | 2 | 0.75 |
| 6 | 0.9 | 0.9 | 0.25 | 2 | 0.85 |
| 7 | 0.9 | 0.9 | 0.25 | 3 | 0.65 |
| 8 | 0.9 | 0.9 | 0.25 | 3 | 0.75 |
| 9 | 0.9 | 0.9 | 0.25 | 3 | 0.85 |
| 10 [ref] | 1.25 | 1.40 | 0.42 | 2.1 (mixed) | 0.75 |
| Ancorsteel 737 | | | | | |
| 11 [ref] | 0.6 | 0.45 | 0.30 | 2 | 0.65 |
| 12 [ref] | 0.6 | 0.45 | 0.30 | 2 | 0.75 |
| 13 [ref] | 0.6 | 0.45 | 0.30 | 2 | 0.85 |

Tensile test bars according to SS-EN 10002-1 were produced by compacting the compositions at a compaction pressure of 600 MPa. The samples were sintered in a laboratory belt furnace at sintering temperature of 1120° C. for 30 minutes in an atmosphere of 90% N₂/10% H₂.

In order to study the influence of the cooling rate half of the number of samples were subjected to forced cooling after sintering at a cooling rate of 2° C./second followed by tempering at 200° C. for 60 minutes, while the other half was subjected to normal cooling rate at about 0.8° C./second. Table 2 shows the results corresponding to the normal cooling rate and table 3 shows the results corresponding to the forced cooling rate.

Results

The dimensional change between compacted and sintered samples were measured as well as the tensile strength, according to SS-EN 10002-1, and the micro Vickers hardness at a load of 10 grams according to EN ISO6507-1 were measured.

TABLE 2
Results from measurements of dimensional change, tensile tests
and hardness tests samples subjected to normal cooling rate

| | C- | O- | Dimensional | Tensile | Hard- |
|---|---|---|---|---|---|
| | content | content | change, | strength, | ness, |
| Composition No | (wt %) | (wt %) | (%) | (MPa) | HV10 |
| 1. (1 wt % Cu) | 0.65 | 0.011 | −0.18 | 661 | 196 |
| 2. (1 wt % Cu) | 0.73 | 0.012 | −0.17 | 655 | 199 |
| 3. (1 wt % Cu) | 0.83 | 0.011 | −0.16 | 694 | 227 |
| 4. (2 wt % Cu) | 0.59 | 0.009 | 0.01 | 836 | 264 |
| 5. (2 wt % Cu) | 0.71 | 0.010 | 0.00 | 778 | 319 |
| 6. (2 wt % Cu) | 0.78 | 0.011 | −0.02 | 631 | 395 |
| 7. (3 wt % Cu) | 0.65 | 0.012 | 0.27 | 860 | 351 |
| 8. (3 wt % Cu) | 0.71 | 0.011 | 0.21 | 696 | 356 |
| 9. (3 wt % Cu) | 0.83 | 0.012 | 0.11 | 625 | 367 |
| 10 [ref] | 0.71 | 0.014 | 0.12 | 723 | 411 |
| 11 [ref] | 0.64 | 0.009 | 0.31 | 732 | 291 |
| 12 [ref] | 0.72 | 0.010 | 0.32 | 739 | 332 |
| 13 [ref] | 0.80 | 0.011 | 0.32 | 711 | 339 |

TABLE 3
Results from measurements of dimensional change,
tensile tests and hardness tests samples subjected
to forced cooling (sinter hardened) rate

| | C- | O- | Dimensional | Tensile | Hard- |
|---|---|---|---|---|---|
| | content | content | change, | strength, | ness, |
| Composition No | (wt %) | (wt %) | (%) | (MPa) | HV10 |
| 1. (1 wt % Cu) | 0.64 | 0.031 | −0.06 | 1061 | 389 |
| 2. (1 wt % Cu) | 0.75 | 0.034 | −0.05 | 1040 | 406 |
| 3. (1 wt % Cu) | 0.82 | 0.029 | −0.08 | 998 | 400 |
| 4. (2 wt % Cu) | 0.65 | 0.033 | 0.11 | 1109 | 372 |
| 5. (2 wt % Cu) | 0.76 | 0.034 | 0.07 | 1036 | 386 |
| 6. (2 wt % Cu) | 0.83 | 0.029 | 0.03 | 953 | 388 |
| 7. (3 wt % Cu) | 0.63 | 0.030 | 0.33 | 1019 | 355 |
| 8. (3 wt % Cu) | 0.75 | 0.030 | 0.21 | 993 | 372 |
| 9. (3 wt % Cu) | 0.83 | 0.029 | 0.08 | 954 | 375 |
| 10 [ref] | 0.74 | 0.032 | 0.14 | 980 | 394 |
| 11 [ref] | 0.64 | 0.025 | 0.32 | 789 | 329 |
| 12 [ref] | 0.73 | 0.024 | 0.32 | 801 | 359 |
| 13 [ref] | 0.82 | 0.027 | 0.33 | 794 | 370 |

Table 2 and 3 shows that tensile strength and hardness values, both for sinter hardened samples and samples cooled at normal cooling rates, for samples produced from the compositions 1-9 reach the same level as samples produced from reference composition 10 having higher contents of costly alloying elements such as Ni and Mo.

Regarding the Cu-content, which also is desired to be kept as low as possible due to high copper prices; it can be seen that the dimensional change both in amount and in variance due to variations of the carbon content, are much higher for compositions 7-9 having a Cu-content of 3 wt %, than for compositions 1-3 having a Cu-content of 1 wt % as well as compositions 4-6 having a Cu-content of 2 wt %. Therefore according to the invention the copper content should preferably be at most 3 wt %, more preferably at most 2.5 wt %, more preferably at most 2.0 wt %.

Regarding compositions 1-3 the amount of the Dimensional change during normal cooling rate are higher than the reference composition 10, however the variance due to carbon content is very low why these results are also comparably good. During forced cooling rate, however, the amount of dimensional change is low as well as its variance.

Regarding compositions 4-6 the amount of the Dimensional change during normal cooling is almost zero and the variance due to carbon content is also very low. During forced cooling rate, the amount of dimensional change is somewhat higher, but still lower than the reference composition 10. The variance is also somewhat higher but since the amount is comparably low this is not an important issue.

Regarding the reference compositions 11, 12 and 13 it can be noticed that a lower tensile strength is obtained, especially for the samples subjected to forced cooling. Further the dimensional change is comparably high in relation to the compositions according to the invention.

Dimensional Change

The dimensional change between compacted and sintered samples should be less than +−0.35%, preferably less than +−0.3%, more preferably less than 0.2%.

Tensile Strength

Preferably the tensile strength should be above 900 MPa, more preferably above 920 MPa, when subjected to fast cooling and tempering.

1. A water-atomized iron-based powder pre-alloyed with Ni and Mo at contents by weight-%:
0.75-1.1 Ni,
0.75-1.1 Mo, and
Mn<0.45,
the iron-based powder further including 0.5-3.0% by weight of Cu and inevitable impurities, the balance being Fe.

2. A water-atomized iron-based powder according to claim 1, wherein the content of Mo is more than 0.8 weight-%.

3. A water-atomized iron-based powder according to claim 1, wherein the content of Mn is less than 0.35 weight-%.

4. A water-atomized iron-based powder according to claim 1, wherein at least a portion or the total amount of Cu is diffusion bonded to the surface of the Ni- and Mo-alloyed Fe-powder.

5. A water-atomized iron-based powder according to claim 4, wherein all of the Cu is diffusion bonded to the surface of the Ni- and Mo-alloyed Fe-powder.

6. A water-atomized iron-based powder according to claim 1, wherein at least portion of the total amount of Cu is bonded to the surface of the Ni- and Mo-alloyed Fe-powder by means of a binding agent.

7. A water-atomized iron-based powder according to claim 6, wherein all of the Cu is bonded to the surface of the Ni- and Mo-alloyed Fe-powder by means of a binding agent.

8. A water-atomized iron-based powder according to claim 1, wherein at least a portion or the total amount of Cu is admixed to the Ni- and Mo-alloyed Fe-powder.

9. A water-atomized iron-based powder according to claim 8, wherein all of the Cu is admixed to the Ni- and Mo-alloyed Fe-powder.

10. A water-atomized iron-based powder according to claim 1, wherein the content of C in the Ni- and Mo-alloyed Fe-powder is at most 0.02 weight-%.

11. A water-atomized iron-based powder according to claim 1, wherein the content of O in the Ni- and Mo-alloyed Fe-powder is at most 0.25 weight-%.

12. An alloyed iron-based powder composition comprising a water-atomized iron-based powder according to claim 1, graphite in an amount of 0.4-0.9 weight-%, lubricants and optionally other additives.

13. An alloyed iron-based powder composition containing a water-atomized iron-based powder according to claim 1, graphite in an amount of 0.4-0.9 weight-%, lubricants and optionally other additives wherein at least one of graphite, lubricants and optionally other elements are bonded to the surface of Ni- and Mo-alloyed Fe-powder.

14. Method for producing a component comprising:
a. providing a powder metallurgical composition according to claim 12,
b. compacting the powder metallurgical composition; and
c. sintering the compacted powder metallurgical composition in a reducing or neutral atmosphere, at an atmospheric pressure or below, and at a temperature above 1000° C.

15. Method according to claim 14 wherein in b) the compaction pressure is up to 2000 MPa.

16. Method according to claim 14 wherein in c) the sintering temperature is performed at a temperature range of 1000° C. to 1400° C.

17. A sintered component produced from the alloyed iron-based powder composition according to claim 11.

18. A water-atomized iron-based powder according to claim 2, wherein the content of Mn is less than 0.35 weight-%.

19. A water-atomized iron-based powder according to claim 2, wherein at least a portion or the total amount of Cu is diffusion bonded to the surface of the Ni- and Mo-alloyed Fe-powder.

20. A water-atomized iron-based powder according to claim 3, wherein at least a portion or the total amount of Cu is diffusion bonded to the surface of the Ni- and Mo-alloyed Fe-powder.

21. Method for producing a component comprising:
a. providing a powder metallurgical composition according to claim 13,
b. compacting the powder metallurgical composition; and
c. sintering the compacted powder metallurgical composition in a reducing or neutral atmosphere, at an atmospheric pressure or below, and at a temperature above 1000° C.

22. Method according to claim 15 wherein in c) the sintering temperature is performed at a temperature range of 1000° C. to 1400° C.

23. A sintered component produced from the alloyed iron-based powder composition according to claim 12.
